(19) United States
(12) Patent Application Publication
(10) Pub. No.: US 2015/0040240 A1
(43) Pub. Date: Feb. 5, 2015

(54) SYSTEM AND METHOD FOR SOFTWARE PIRACY MONETIZATION

(71) Applicant: Corel Corporation, Ottawa (CA)

(72) Inventors: Alireza Fakhraei, Ottawa (CA); Gerard Metrailler, Orleans (CA)

(21) Appl. No.: 14/449,727

(22) Filed: Aug. 1, 2014

Related U.S. Application Data
(60) Provisional application No. 61/861,358, filed on Aug. 1, 2013.

(51) Int. Cl. G06F 21/64; G06F 21/12; G06Q 20/12

(52) U.S. Cl. CPC G06F 21/645; G06Q 20/1235; G06F 21/126; G06F 2221/2115; G06F 2221/033
USPC 726/26

(57) ABSTRACT

A method includes the steps of: providing a software product configured to run on a local computer and to perform a piracy monetization checksum based process; providing a list of valid checksums for a distribution filename of the software product version; connecting by computer the local computer with a software company server; identifying by computer a unique computer identification of the local computer; following a launch, sending the unique computer identification and a checksum of at least one distribution filename on the local computer to the software company server; comparing at the software company server the checksum to the list of valid checksums; and responsive to the step of comparing on detection of a non-authorized checksum, sending a message from the software company server to the local computer, the message configured to perform a piracy monetization action. A method using checksums and serial numbers is also described.

### CROSS-REFERENCE TO RELATED APPLICATIONS

This application claims priority to and the benefit of co-pending U.S. Provisional Patent Application Ser. No. 61/861,358, SYSTEM AND METHOD FOR SOFTWARE PIRACY MONETIZATION, filed Aug. 1, 2013, which application is incorporated herein by reference in its entirety for all purposes.

### FIELD OF THE INVENTION

The invention relates to a system and method for software piracy monetization.

### BACKGROUND OF THE INVENTION

Software piracy costs the software industry millions of dollars of lost revenue. There are also fewer jobs in the software industry than there otherwise could be, because of lost revenue attributable to software piracy. It matter not whether software piracy is perpetrated as a criminal activity, or by unsuspecting victims of software piracy, the result is the same, a negative impact on the software industry.

Whether software piracy is done intentionally for profit (e.g. organized crime), for individual criminal gain, or with intent to share “freely” (e.g. Robin Hood intent, stealing from those with resources, to freely share with others), each pirated copy of a software product is illegal, and causes damage to the software company as well as all of its stake holders.

### SUMMARY OF THE INVENTION

According to one aspect, a method includes the steps of: providing a computer readable non-transitory storage medium including a computer readable code as a software product version configured to run on a local computer and configured to perform a piracy monetization checksum based process; providing a list of valid checksums for a distribution filename of the software product version on a software company server; running the computer readable code on the local computer; connecting by computer the local computer with a software company server; identifying by computer a unique computer identification of the local computer having the software product version installed thereon; following at least one launch of the software product version, sending by computer as a background operation the unique computer identification and a checksum of at least one distribution filename on the local computer associated with the software product version from the local computer to the software company server; comparing by computer at the software company server the checksum of the at least one distribution filename of the software product version installed on the unique computer to the list of valid checksums for a distribution filename of the software product version; and responsive to the step of comparing by computer a checksum of the distribution filename of the software product version installed on the unique computer to the list of valid checksums for a distribution filename of the software product version, on detection of a non-authorized checksum, sending a message from the software company server to the local computer or turning on an existing message in the software product, the message configured to perform a piracy monetization action.

In one embodiment, the piracy monetization action includes displaying a message which warns a user of a pirated installation of the software product version and invites the user to purchase the software product version.

In another embodiment, following a period of time or number of software launches since the warning, the piracy monetization action includes reverting the software product version to a state of diminished functionality or stopping the software product from being launched anymore and displaying a message which notifies a user of a pirated installation of the software product version and invites the user to purchase the software product version.

According to another aspect, a method includes the steps of: providing a computer readable non-transitory storage medium including a computer readable code as a software product version configured to run on a local computer and configured to perform a piracy monetization checksum based process; providing a list of valid checksums for a distribution filename of the software product version on a software company server; providing a list of authorized serial number or a list of pirated serial numbers on the software company server; running the computer readable code on the local computer; connecting by computer the local computer with a software company server; identifying by computer a unique computer identification of the local computer having the software product version installed thereon; following at least one launch of the software product version, sending by computer as a background operation the unique computer identification and a checksum of at least one distribution filename on the local computer and a serial number associated with the software product version from the local computer to the software company server; comparing by computer at the software company server the checksum of the at least one distribution filename of the software product version installed on the unique computer to the list of valid checksums for a distribution filename of the software product version and comparing the serial number to a list of authorized serial number or comparing the serial number to a list of pirated serial numbers; and responsive to the step of comparing by computer at the software company server the checksum of the at least one distribution filename of the software product version installed on the unique computer to the list of valid checksums for a distribution filename of the software product version and comparing the serial number to a list of authorized serial number or comparing the serial number to a list of pirated serial, on detection of a non-authorized checksum or on detection of a pirated serial number, sending a message from the software company server to the local computer or turning on an existing message in the software product, the message configured to perform a piracy monetization action.

In one embodiment, the piracy monetization action includes displaying a message which warns a user of a pirated installation of the software product version and invites the user to purchase the software product version.

In another embodiment, following a period of time or number of software launches since the warning, the piracy monetization action includes reverting the software product version to a state of diminished functionality or stopping the software product from being launched anymore and displaying a message which notifies a user of a pirated installation of the software product version and invites the user to purchase the software product version.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 shows a process block diagram of one exemplary embodiment of a software piracy monetization process;

FIG. 2 shows a block diagram of a computer system suitable to perform the piracy monetization computer processes described herein;

FIG. 3 shows a screen shot of an exemplary first warning to a suspected user of pirated software; and

FIG. 4 shows a screen shot of an exemplary final warning to a suspected user of pirated software.

### DETAILED DESCRIPTION

DEFINITIONS: Piracy as used herein refers to the acquisition and use of computer software through unauthorized means, typically for the purpose of avoiding payment or to pay a purchase price significantly below market value by “buying” pirated software from a pirate distributor. Piracy generally falls into two categories, intentional and unintentional piracy. Intentional piracy includes individuals or groups of persons who take one or more overt actions to obtain and use unauthorized copies of software without payment. Unintentional piracy includes victims of piracy, such as those who buy used or discounted software products which turn out to be of a pirated nature. Examples of unintentional piracy include buyers of pirated software at auction sites or software stores which masquerade as legitimate discount software stores, but actually sell pirated software. It has been well established that pirated software equates to criminal theft. Therefore, individuals using pirated software are either knowingly and willing participating in theft, or they are another victim of software piracy theft.

Serial number: A serial number is a unique string of characters which can be provided with or for each distribution copy of a software product. The characters may include numbers, letters, and any other suitable symbols in any case and in any order. The serial number may or may not be case sensitive (e.g. lower case or upper case).

Authorization code: An authorization number is a number or code which also includes a unique string of characters which can be provided with or for each distribution copy of a software product, or which can be provided via telephone by a software company in connection with a consumer purchase of a software product. The characters may include numbers, letters, and any other suitable symbols in any case and in any order. The authorization code may or may not be case sensitive (e.g. lower case or upper case).

Authentication: One aspect of identifying a legitimately purchased software product can include a two factor authentication. For example, a user might be prompted to enter a serial number followed by an authorization code. In some cases, a user is directed to call a phone number associated with a software company. The representative of the software company asks the user for their serial number, and if the serial number appears to be legitimate, provides the consumer user with a working authorization code. The user enters both numbers, such as by entering both strings into a software generated pop-up window, and if all goes well, the software indicates that it is a properly purchased and registered copy. In a similar case, the user of a free demonstration distribution copy of a software product, during or at the end of an evaluation period, calls the company to purchase the software. Following an accepted payment (e.g. credit card payment by telephone), the user is given a serial number and authorization code by phone.

Reversion is where a software product has two or more levels of functionality, and the software is caused to change back to, or “revert” to a lower level of functionality having less functionality than a previously operating level of functionality. As applied in anti-piracy actions, reversion can, for example, cause a fully functioning software product such as a computer drawing program to revert to viewer only functionality. Or, in other embodiments, a fully functioning software product can be converted by reversion to an evaluation version of the software, past its evaluation time period (i.e. the evaluation period has expired).

### Software Piracy and Serial Numbers

Software piracy often begins with a serial number. The serial number is typically one that was originally issued for legitimate use by a consumer of the software product following a proper purchase. The details of any particular end user license agreement (EULA) between the software company and the user purchaser are less important (e.g. how many installed copies a consumer is allowed to have while remaining within the EULA). In software piracy, the pirate uses one or more such passwords to create one or more additional illegal copies of the software product.

The most common sources for pirated passwords are lists of passwords posted online Such lists can be posted at password sharing websites, or shared by any other sharing technique ranging from email to posts on pages at social media or via other well know piracy sharing sites, discussion groups, and boards. Torrent type sharing via many network connected computers is also widely used.

There are a number of ways that a software company can detect pirated serial numbers. Once detected and determined to be pirated, the serial number can be entered into a database of known pirated serial numbers.

### Use of Serial Numbers

In some cases, simply installing a copy of a distribution version of a software product and installing a pirated serial number is sufficient to use the product as if it were purchased. In other cases, such as for example, converting a free demonstration installation into a working “purchased copy” installation, a second authentication number is needed following entry of a pirated serial number.

### Levels of Software Functionality

Software purchased from a software company or one of its authorized distribution centers (e.g. big box stores or online retailers) often comes in one or more feature set versions with a serial number. Generally installing the software and entering a serial number (e.g. a printed serial number within the package) during a registration and/or activation process leads to a proper authorized and operating working copy of the product.

It is also common for software companies to offer a “try before you buy” option via a demonstration copy. Often, such demonstration copies are free online downloads. During, near the end of, at the end of, or after the trial period, a prospective consumer can purchase the software product, as by online or telephone credit card purchase. As described hereinabove, the consumer typically receives a serial number and authentication code following such a purchase.

It has also been the case that a demonstration copy might revert to a partially working state after the trial period, where there has been no purchase. For example, after a trial period expires, a computer drawing program might offer only “viewer” functionality, e.g. only showing graphics files as drawings on the screen. Typically, such a reverted installation no longer allows editing. An installed software product that has not yet been purchased can offer a consumer user a purchase option, such as for example, by way of a pop-up window. On detection of a pirated installation, software functionality can be reduced to non-functional, such as a non-functional state which follows expiration of a trial version. Or, software functionality can be reduced to a lower state of functionality, such as, for example, where a drawing program operates only as a graphics file viewer.

Software Interaction with a Software Company Server

It has become common for software to communicate with a computer server of the software company, such as via the Internet. One reason for such communications is to notify the user of the software of an available software update. Another reason is to enable software features which can be made available to a user, such as for example, under a software subscription purchase model. Such features were described in co-pending patent application Ser. No. 13/826,836, SYSTEM AND METHOD FOR SOFTWARE FEATURE MANAGEMENT, filed Mar. 14, 2013. In still other communication methods, computers software can communicate with a computer server of the software company to provide “crowd sourcing” information to improve the product, such as was described in co-pending patent application Ser. No. 61/857,005, ENHANCED BRUSH SEARCH FOR A COMPUTER PAINTING OR DRAWING PROGRAM, filed Jul. 22, 2013.

One way that a user installation can send information back to the software company is at various times or at various user events. For example, on installation and registration, registration information can be sent back to the manufacturer. While a user expects that registration will “identify” a user to the manufacturer of the software, following an event such as registration, privacy can be a concern with regard to software communicating with a software company server.

To address such privacy concerns, one way to identify a user of a software installation is by one or more user software and/or hardware elements of the user machine. Also, related information, such as, for example, a user internet protocol (IP) address can be noted. By noting some such unique characteristic of a user installation, a unique database entry can be established by the software company which is for all practical purposes anonymous and can even be maintained separately from user registration information, such as a user name.

### Key Generators

One well known and particularly revenue damaging method of software privacy uses a key generator. A key generator can illegally mimic the software authorization process of a software company. The well-known principle of operation involves use of one or more serial numbers, often serial numbers provided initially with otherwise initially legitimate distribution copies of the software product. The key generator then computes the same authorization code that can be obtained by a user from the software company following a purchase of the software, such as by credit card transaction online or more likely by telephone. The illegal (criminal) key generator allows any user to illegally convert a trial version of the software to a fully working “authorized” version, without any payment and without any interaction with the software company.

### Anti-Piracy

It was realized that there are several ways that a software company can build a list of pirated serial numbers which can mirror the pirated serial numbers being used for theft of the software product. It was also realized that a software company can collect known pirated serial numbers and store a list of known pirated serial numbers at a computer company server. It was further realized that installations having a pirated serial number can be caused to display a notice of pirated software to the user, thus putting the user on legal notice that the installed copy is an illegal copy having a known pirated serial number. The user is given information on how to contact to the software company.

In the highly unusual case of a mistake, the software company can cause that installation and/or serial number to no longer indicate an illegal installation. However, in the vast majority of cases, the user is now on legal notice that they have in their possession an illegal installation of the software.

As explained hereinabove, most software companies understand that some illegal installations are not intentional in the sense that the consumer believed in good faith that they were buying a legitimate used or otherwise discounted new version of the software. While that type of user is probably not criminally liable for the installation (no intent to steal the software from the software company) and might not even be liable for damages to the software company under a civil theory, following notice, the situation is changed. Now, the user needs to consciously decide with intent whether to contact the software company to arrange a proper license to the use the software, to uninstall the software, or to cross the line into software piracy by intentionally using a known illegal software installation.

Once legal notice has been given, a software company server can log illegal use of their software and begin to build a civil and/or criminal case against any illegal installation. However, while not “off the table”, such prosecution of a civil or criminal case (working with relevant public enforcement authorities) is costly in both time and money. Also, short of prosecuting organized criminal activities, civil or criminal prosecution of an individual is unpleasant, can result in less than favorable publicity for the software company, and generally does little to solve the underlying problem of software piracy.

What is needed is a system and method for piracy monetization.

It was found that forced reversion for anonymous users using pirated serial numbers to the functionality of an expired trial is effective. As described in more detail hereinbelow, users of pirated serial numbers who wish to remain anonymous simply need to uninstall the pirated copy of the software to drop from “sight” of the software company server. Alternatively, and with monetization benefits for software companies, users who wish to pay and register their unintentionally pirated copies, typically under amnesty programs, can contact the manufacturer and pay the license fee. Where such accommodation is achieved, no further action need take place, and both parties are spared costly and unpleasant litigation.

### Identification of Pirated Serial Numbers

Software manufactures can identify known and/or suspected pirated serial numbers by any suitable means. Such serial numbers can be added to one or more lists of known and/or suspected pirate serial numbers.

In some embodiments, pirated serial numbers can be identified manually and/or automatically by searching the Internet for posted listings of one or more pirated serial numbers. Such listings typically post a software product name and one or more pirated serial numbers.

In some embodiments, the software can report its serial number one or more times back to the software company server. The server can associate each serial number with some indicia of where it is installed (e.g. a unique computer identification). For example, a serial number might be associated with one or more IP addresses, a geographic area (e.g. country), and/or particular computer or particular computer configurations (e.g. type processor and/or type graphics card). There is generally less concern, depending on the terms of the EULA where a serial number appears a few times. However, when a serial number appears hundreds of time, it can be added to the list of know pirated serial numbers with a relatively high degree of confidence.

In other embodiments, a software company can verify that a serial number was actually issued at least once by the software company itself. If a serial number was never issued by the software company, it is a pirated serial number by definition.

### Piracy Monetization Embodiment

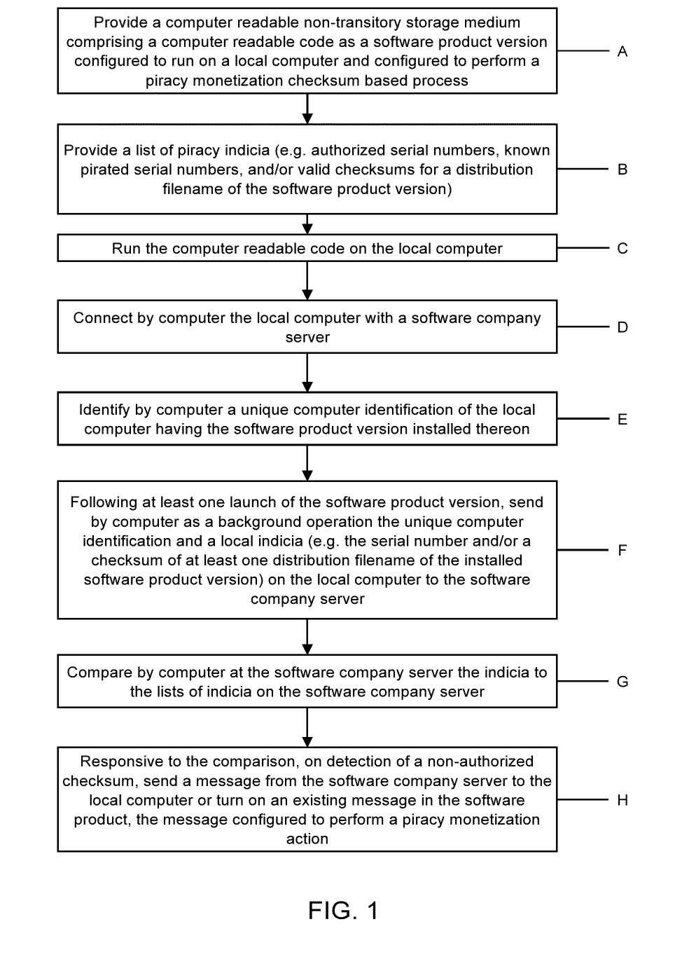

FIG. 1 shows a block diagram of the process steps of one exemplary embodiment of a software piracy monetization process. A) provide a computer readable non-transitory storage medium comprising a computer readable code as a software product version configured to run on a local computer and configured to perform a piracy monetization checksum based process; B) provide a list of piracy indicia (e.g. authorized serial numbers, known pirated serial numbers, and/or valid checksums for a distribution filename of the software product version); C) run the computer readable code on the local computer; D) connect by computer the local computer with a software company server; E) identify by computer a unique computer identification of the local computer having the software product version installed thereon; F) following at least one launch of the software product version, send by computer as a background operation the unique computer identification and a local indicia (e.g. the serial number and/or a checksum of at least one distribution filename of the installed software product version) on the local computer to the software company server; G) compare by computer at the software company server the indicia to the lists of indicia on the software company server; and H) responsive to the comparison, on detection of a non-authorized checksum, send a message from the software company server to the local computer or turn on an existing message in the software product, the message configured to perform a piracy monetization action. One or more anti-piracy actions (e.g. “reversion”) can be taken. Such anti-piracy actions can include actions taken immediately and further actions taken over time or over number of uses of the pirated software.

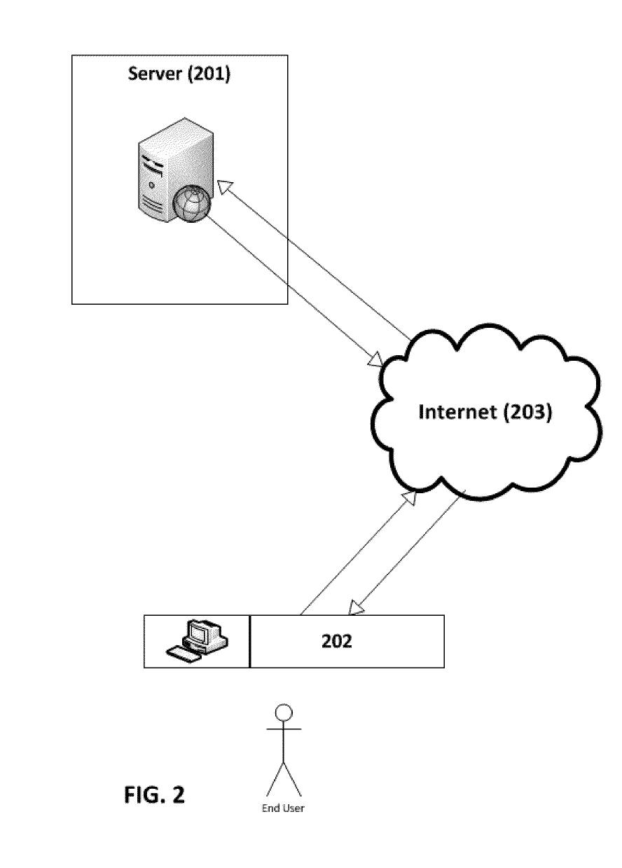

FIG. 2 shows a block diagram of a computer system suitable to perform the software piracy monetization computer processes described herein. A computer server 201, such as, for example, a software company server, is communicatively coupled to a network, such as the Internet, by any suitable wired or wireless means. One or more local computers 202 can run the software product, such as for example, a painting or drawing program. A user at a local computer 202 has an installed copy of a software product manufactured by the software company. In some embodiments, local computer 202 reports unique, typically anonymous information, such as for example, about the hardware installed in local computer (e.g. to form a “digital finger print”) 202 back to server 201, such as for example, via the “cloud” 203 (e.g. the Internet) back to server 202. Software on the software company computer server is configured to receive information from the local computer, such as the digital finger print, installed software product serial number, a checksum of one or more files of the software product, etc. If the installed serial number matches one of the serial numbers on the list of known pirated serial numbers, certain actions, such as, for example, “reversion”, or stopping the program from launching at all, can be taken.

In some embodiments a pirate “cookie” similar to, but not the same as a browser cookie, can be installed on the user's computer. The pirate cookie identifies to the installed software that the installation is a pirated installation of the software. The software can then begin a series of actions based on the installation of the pirate cookie without further direction or instruction from the manufacturer's server.

In some embodiments, a pirated software installation, a pop-up window or equivalent type of notice can be displayed on the user's computer display (e.g. an existing message in the software product). The window can give legal notice of an illegal (pirated copy) installation of the software. The window can further offer instructions on how to contact the software company and/or how to uninstall the illegal installation. In some embodiments, there can be a progression of notices based on factors, such as for example, time since detection of a pirated installation and/or number of program launches. In some embodiments, the message can increase in an “intensity” of notification. For example, a later screen message can inform the user that further use of the illegal copy may convert their use from unintentional victim of piracy to intentional theft as a pirate with possible civil and/or criminal consequences associated with continued use of an illegal installation using a pirated serial number or other such circumvention technique. Also, in some embodiments, the software product can be completely stopped from being launched anymore

### Anti-Piracy Embodiment and Repeated Use of Key Generators

Unfortunately some persons do not acknowledge that use of stolen software is not okay. Such users will continue to pirate software indefinitely until prosecuted or stopped by other means. Such users, on seeing notice of use of a pirated serial number will attempt to defeat the notice. One common attempt is to download a “fresh” free trial version or to use the manufacturer purchase and authorize window repeatedly with newly obtained pirated serial numbers which might not yet be in the list of pirated serial numbers on the software company server.

Anti-piracy efforts can be made more effective by inhibiting such repeated piracy efforts. For example, in some embodiments, as described hereinabove, a pirate cookie can be installed on a user's computer which is running an illegal installation of the software. Either associated with detection of a pirate cookie, or by any other suitable means (e.g. mere detection of a matched installed serial number to a pirate serial number and/or number of program launches since notification of an illegal installation), the software feature which allows entry of a serial number and authorization number can be permanently disabled. Without the ability to enter a serial number and authorization number, a key generator is rendered useless. Moreover, a “fresh installation” of another free trial can be limited so as also not to provide the serial number/authorization code pop-up window. Albeit still anonymous as to user identity, the user machine identity is known to the software company server which can take further suppression measures (e.g. pirate cookies and the like) to suppress repeated use of pirated serial numbers.

### Exemplary Piracy Monetization Campaign Targets Users of a Key Generator

### EXAMPLE 1

Example 1 describes an anti-piracy campaign which targets users of a key generator (Keygen Users) according to the computer processes described herein. In example 1, a “pirate” user downloads a trial copy of the software product. When a “Trial Dialog” box shows up on the screen, the user chooses to purchase the product offline. However, instead of calling the software company “offline”, the user runs an illegal key generator to circumvent the software company's digital rights management (DRM) and/or copyright controls. The illegal key generator generates a “pirate” serial number (which may or may not be a serial number which was originally provided by the software company). The pirated serial number passes the validation test by the installed trial software product (even, in some cases where the serial number was never originally issued by the software company). The illegal key generator also provides the “software pirate to be” with an activation code to activate the product and to convert it from a Trial mode or functionality to an Activated installed “retail” software product. In most countries, such use of a key generator is believed to be an illegal act under both civil (i.e. fraud, circumvention (U.S.), etc.) and criminal law (i.e. theft).

Now turning in more detail to the exemplary steps of one embodiment of the process:

Step 1) user launches the product on his or her machine (client or “local computer”).

Step 2) client application requests new contents and messages from server, in the background (transparent to the user).

Client generates a unique hardware fingerprint, in this example 1, by getting the hashed value of multiple hardware components.

Client creates a request that identifies the product version (licenseId), machine (hardware fingerprint), distribution (serial number). Below is a sample request:

<?xml version=“1.0” encoding=“utf-8” ?>
<multipart>
<productmanifest>
<licenseinfo licenseid=“<product version id>” serialnumber=
“<serial number>” language=“<product language>” >
</licenseinfo>
</productmanifest>
<systeminfo hardwarefingerprint=“<hardware fingerprint>” />
<request type=“messages”>
</request>
</multipart>

Client sends this request to server (i.e. a software company server) to get the online content and messages.

Server receives the request from client.

Server looks up the serial number against all Corel generated serial numbers.

If the serial number cannot be found, flag the requesting machine as pirate.

Else lookup the serial number against all blacklisted serial numbers that were leaked on Torrent sites and used excessively.

If the serial number is found in the blacklisted table, flag the requesting machine as pirate.

Collect all contents and messages relevant to the product, specified by the licenseid.

Return the content and message collection along with the flag, specifying whether the machine is using a pirated copy or not, to the requesting machine (client).

Step 3) Client app registers the piracy flag.

Step 4) Client app sets the schedule for trial dialogs to “never show up again” to disallow the user from seeing the trial dialogs and going through the offline purchase again and using the keygen on this machine.

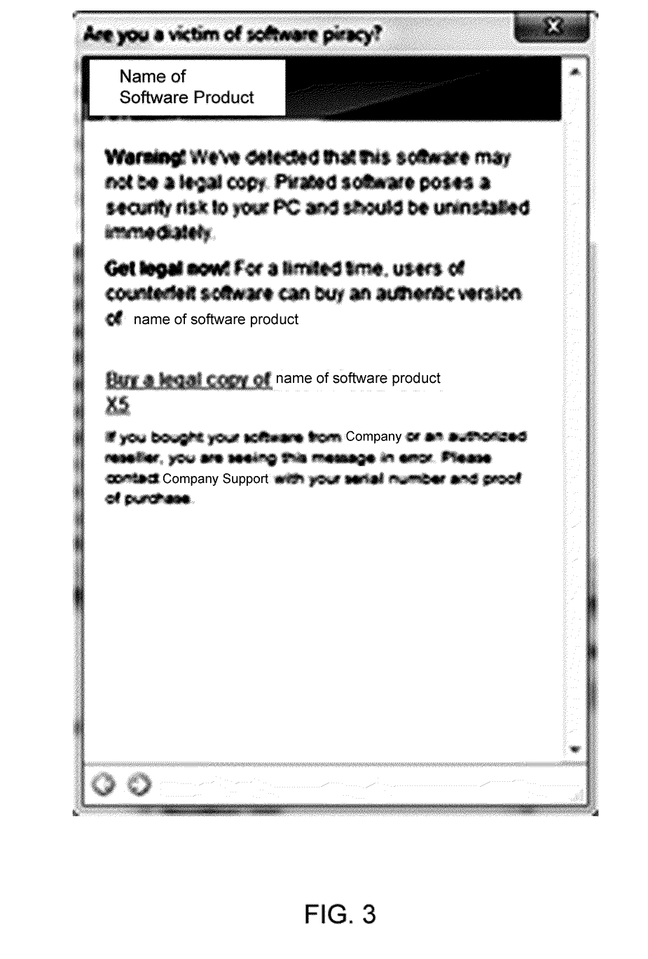

Step 5) If the machine is flagged as pirate, client app shows a message to the user, such as the exemplary message pop-up window of FIG. 3.

Step 6) User has an exemplary grace period of 6 launches to act on the above mentioned message and purchase a legitimate copy either directly from e-store or from a reseller.

Step 7) Users who purchase a legitimate copy will uninstall the pirated copy and install a legitimate copy on the machine and use the legally installed software product.

Step 8) If user does not act on the message, after the exemplary 6 launches, the product will terminate the activation record and will turn into viewer mode (an exemplary form of reversion), in that user can only open and view the files that were created but cannot update or modify them.

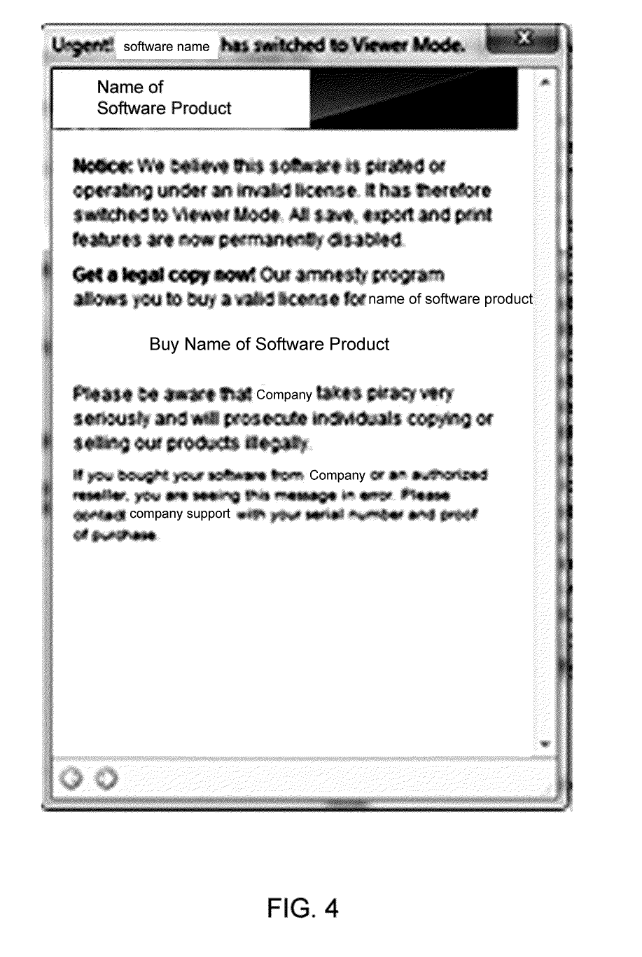

Step 9) The user will now see a message such as the exemplary message of FIG. 4 on every launch, going forward unless or until they take action to properly purchase the software product.

### Anti-Piracy Embodiment and Circumvention

Unfortunately some slightly higher skilled pirates may be able to build a “patch” that a user can install to remove some or all of the anti-piracy features of the illegally installed software. It was further realized that the software company server can detect some of all of such patches intended to circumvent the software company's anti-piracy efforts.

For example, in some embodiments, at some user event, such as for example at program launch, the software can send a message to the software company server which includes an indication of the integrity of one or more files of the installed software. One indication of the integrity of one or more of the installed files is the check sum of those installed files. Where an improper check sum indicates tampering, one or more anti-piracy actions can be taken. As described hereinabove, such notification can change progress from friendly notice to dire warnings. For example, a first notice might inform the user of the software that a corrupted file has been detected and suggest a repair (where available) and/or reinstallation of the program. Later notices might identify the installation of suspected or know pirate circumvention based on one or more known indicia of program modification, such as, for example, a known check sum associated with a known type of pirate patch. In such cases of a known pirate patch, there can be further actions, such as, for example, installation of one or more pirate cookies.

### Exemplary Piracy Monetization Campaign Targets Binary Crack Users.

### EXAMPLE 2

In example 2, a pirate user downloads a trial copy of a software product and downloads and applies a patch created by hackers. The patch circumvents software licensing measures built into the product. The patch turns off the license validation module and unlocks the trial product into a fully functional purchased product that can run as an unlocked product indefinitely.

Step 1) user launches the product on his or her machine (client).

Step 2) client app requests new contents and messages from server, in the background.

Client generates the unique hardware fingerprint by getting the hashed value of multiple hardware components.

Client creates a request that identifies the product version (licenseId), machine (hardware fingerprint), distribution (serial number) as well as the integrity validation section (file checksum). Below is an exemplary request:

<?xml version=“1.0” encoding=“utf-8” ?>
<multipart>
<productmanifest>
<licenseinfo licenseid=“<product version id>” serialnumber=
“<serial number>” language=“<product language>” >
</licenseinfo>
</productmanifest>
<systeminfo hardwarefingerprint=“<hardware fingerprint>” />
<fileinfolist>
<fileinfo filename=“Product.EXE” version=“16”
checksum=“37b64e” />
</fileinfolist>
<request type=“messages”>
</request>
</multipart>

Client sends this request to server to get the online content and messages.

Server receives the request from client.

Server validates the file checksum against the database of all original file checksums based on the filename and the file version.

If the request checksum doesn't match what is in the database, flag the requesting machine as binary-cracked pirate.

Collect all contents and messages relevant to the product, specified by the licenseid.

Return the content and message collection along with the flag, specifying whether the machine is using a binary-cracked pirated copy or not, to the requesting machine (client).

Step 3) Client app registers the piracy flag.

Step 4) If the machine is flagged as pirate, client app shows the message of FIG. 3 to the user.

Step 5) User has a grace period of 6 launches to act on the above mentioned message and purchase a legitimate copy either directly from e-store or from a reseller.

Step 6) Users who purchase a legitimate copy will uninstall the pirated copy and install the legitimate copy on the machine and enjoy the product.

Step 7) If user doesn't act on the message, after 6 launches, the product will terminate itself and won't launch.

Step 8) The user will now see the message of FIG. 4 on every launch before the product terminates the launch, going forward until they take action.

### Anti-Piracy Embodiment and Usage Reporting

Where repeated know pirate installations occur, there can be further anti-piracy measures, including detailed reporting of the usage of the pirated installation. Such information is still anonymous to the software company computer server as to personal information, such as for example, a user's name. However, in extreme cases where civil prosecution and/or a criminal complaint cannot be avoided, such information can be supplied to law firms preparing civil litigation for discovery of the user's real identity and/or to law enforcement agencies anywhere in the world in association with a criminal complaint.

Software described hereinabove can be supplied or provided on a computer readable non-transitory storage medium. A computer readable non-transitory storage medium as non-transitory data storage includes any data stored on any suitable media in a non-fleeting manner. Such data storage includes any suitable computer readable non-transitory storage medium, including, but not limited to hard drives, non-volatile RAM, SSD devices, CDs, DVDs, etc.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A method comprising the steps of:
providing a computer readable non-transitory storage medium comprising a computer readable code as a software product version configured to run on a local computer and configured to perform a piracy monetization checksum based process;
providing a list of valid checksums for a distribution filename of said software product version on a software company server;
running said computer readable code on said local computer;
connecting by computer said local computer with a software company server;
identifying by computer a unique computer identification of said local computer having said software product version installed thereon;
following at least one launch of said software product version, sending by computer as a background operation said unique computer identification and a checksum of at least one distribution filename on said local computer associated with said software product version from said local computer to said software company server;
comparing by computer at said software company server said checksum of said at least one distribution filename of said software product version installed on said unique computer to said list of valid checksums for a distribution filename of said software product version; and
responsive to said step of comparing by computer a checksum of said distribution filename of said software product version installed on said unique computer to said list of valid checksums for a distribution filename of said software product version, on detection of a non-authorized checksum, sending a message from said software company server to said local computer or turning on an existing message in said software product, said message configured to perform a piracy monetization action.

2. The method of claim 1, wherein said piracy monetization action comprises displaying a message which warns a user of a pirated installation of said software product version and invites said user to purchase said software product version.

3. The method of claim 2, wherein following a period of time or number of software launches since said warning, said piracy monetization action comprises reverting said software product version to a state of diminished functionality or stopping said software product from being launched anymore and displaying a message which notifies a user of a pirated installation of said software product version and invites said user to purchase said software product version.

4. A method comprising the steps of:
providing a computer readable non-transitory storage medium comprising a computer readable code as a software product version configured to run on a local computer and configured to perform a piracy monetization checksum based process;
providing a list of valid checksums for a distribution filename of said software product version on a software company server;
providing a list of authorized serial number or a list of pirated serial numbers on said software company server;
running said computer readable code on said local computer;
connecting by computer said local computer with a software company server;
identifying by computer a unique computer identification of said local computer having said software product version installed thereon;
following at least one launch of said software product version, sending by computer as a background operation said unique computer identification and a checksum of at least one distribution filename on said local computer and a serial number associated with said software product version from said local computer to said software company server;
comparing by computer at said software company server said checksum of said at least one distribution filename of said software product version installed on said unique computer to said list of valid checksums for a distribution filename of said software product version and comparing said serial number to a list of authorized serial number or comparing said serial number to a list of pirated serial numbers; and
responsive to said step of comparing by computer at said software company server said checksum of said at least one distribution filename of said software product version installed on said unique computer to said list of valid checksums for a distribution filename of said software product version and comparing said serial number to a list of authorized serial number or comparing said serial number to a list of pirated serial, on detection of a non-authorized checksum or on detection of a pirated serial number, sending a message from said software company server to said local computer or turning on an existing message in said software product, said message configured to perform a monetization action.

5. The method of claim 4, wherein said monetization action comprises displaying a message which warns a user of a pirated installation of said software product version and invites said user to purchase said software product version.

6. The method of claim 5, wherein following a period of time or number of software launches since said warning, said monetization action comprises reverting said software product version to a state of diminished functionality or stopping said software product from being launched anymore and displaying a message which notifies a user of a pirated installation of said software product version and invites said user to purchase said software product version.
